(19) United States
(12) Patent Application Publication
(10) Pub. No.: US 2025/0292701 A1
(43) Pub. Date: Sep. 18, 2025

(54) EDGE COMPUTING AND HAPTIC CHORD INSTRUMENT TEACHING AND LEARNING

(71) Applicant: Saint Louis University, St. Louis, MO (US)

(72) Inventor: Flavio Esposito, Brentwood, MO (US)

(21) Appl. No.: 19/077,570

(22) Filed: Mar. 12, 2025

Related U.S. Application Data
(60) Provisional application No. 63/565,975, filed on Mar. 15, 2024.

(51) Int. Cl. G09B 15/06; G06F 3/01

(52) U.S. Cl. CPC G09B 15/06; G06F 3/016

(57) ABSTRACT

Provided herein is a musical training system associated with an edge network. The musical training system can include a wearable device operable to track user finger positions and provide haptic feedback to the user, one or more processors connected to the edge network, and a memory storing instructions that, when executed by the one or more processors, causes the one or more processers to: receive user finger positions from the wearable device, compare the user finger positions to stored optimal finger positions, and cause the wearable device to provide haptic feedback to the user based on the comparison of the user finger position to the stored optimal user finger positions.

### CROSS-REFERENCE TO RELATED APPLICATIONS

This application claims priority to U.S. Provisional Application No. 63/565,975 filed Mar. 15, 2024, the contents of which are entirely incorporated by reference herein.

### FIELD OF DISCLOSURE

The present disclosure relates to systems and methods for training a musician.

### BACKGROUND

Traditional musical training methods involve one-on-one lessons, regular practice, music theory studies, and performance experience. In many cases, musical training requires skilled instructors with years of expertise and precise observational skills to provide training to musicians. Musical training methods can also include video recording and analysis to visually analyze a musician's technique. Metronomes and tuners can be used to help a musician develop timing, rhythm, and ensure correct instrument tuning. Masterclasses and workshops can offer insights from expert musicians but are not personalized for individual learning needs. Some wearable training devices can assist with posture and instrument handling, but do not provide any feedback to a musician. Musical learning software can provide interactive lessons but typically is only useful for beginners due to limitations in advanced feedback mechanisms. Peer review and feedback can be provided from playing in ensembles or for instructors, which can provide personal interaction, but lack consistency and detail. All known methods to train musicians require trained instructors to provide detailed and sophisticated feedback, but still the inconsistencies between instructors can result in frustration or plateauing progression.

Therefore, there is a need for a system to train musicians with detailed levels of instruction without the need for an instructor.

### SUMMARY

Provided herein is a musical training system associated with an edge network. The musical training system can include a wearable device operable to track user finger positions and provide haptic feedback to a user, one or more processors connected to the edge network, and a memory storing instructions that, when executed by the one or more processors, causes the one or more processors to: receive the user finger positions from the wearable device, compare the user finger positions to stored optimal finger positions; and cause the wearable device to provide haptic feedback to the user based on the comparison of the user finger positions to the stored optimal finger positions.

In some aspects, the wearable device can be operable to track user finger position at a submillimeter level. In some aspects, the wearable device can be a glove having one or more sensors and one or more actuators. In some aspects, the one or more sensors can be operable to track the user finger positions and the one or more actuators can be operable to provide the haptic feedback. In some aspects, the stored optimal finger positions can be finger positions collected from a skilled musician playing a song. In some aspects, the edge network can be configured to allow comparison of the user finger positions to the stored optimal finger positions in real-time.

In some aspects, the haptic feedback includes a directed vibration to instruct the user to move one or more fingers in a desired direction towards the stored optimal finger positions in real-time. In some aspects, the stored optimal finger positions can include tracked finger positions from a plurality of musicians for a plurality of songs. In some aspects, the tracked finger positions from the plurality of musicians are analyzed by a machine learning or deep learning model to form the stored optimal finger positions for each song in the plurality of songs. In some aspects, the one or more processors can be further configured to determine a training score based on the comparison of the user finger positions and the stored optimal finger positions and output the training score on a display.

Further provided herein is a method for musical training. The method can include providing a wearable device operable to track user finger positions while a user is playing a musical instrument, receiving the user finger positions, comparing the user finger positions to stored optimal finger positions, and providing, via the wearable device, haptic feedback to the user based on the comparison of the user finger positions to the stored optimal finger positions. In some aspects, the wearable device can be associated with an edge network.

In some aspects, the wearable device can be operable to track user finger position at a submillimeter level. In some aspects, the wearable device can be a glove having one or more sensors and one or more actuators. In some aspects, the one or more sensors can be operable to track user finger positions and the one or more actuators can be operable to provide haptic feedback. In some aspects, the method can further include receiving finger positions from a skilled musician playing a song. In some aspects, the stored optimal finger positions can be the received finger positions the skilled musician.

In some aspects, the edge network is configured to allow comparison of the user finger positions to the stored optimal finger positions in real-time. In some aspects, providing haptic feedback can include providing a directed vibration to instruct the user to move one or more fingers in a desired direction towards the stored optimal finger positions in real-time. In some aspects, the method can further include receiving a plurality of tracked finger positions from a plurality of musicians for a plurality of songs. In some aspects, the tracked finger positions from the plurality of musicians can be analyzed by a machine learning model to form the stored optimal finger positions for each song in the plurality of songs. In some aspects, the method can further include determining a training score based on the comparison of the user finger positions and the stored optimal finger positions and outputting the training score on a display.

Other aspects and iterations of the invention are described more thoroughly below.

### BRIEF DESCRIPTION OF FIGURES

The description will be more fully understood with reference to the following figures and graphs, which are presented as various embodiments of the disclosure and should not be construed as a complete recitation of the scope of the disclosure. It is noted that, for purposes of illustrative clarity, certain elements in various drawings may not be drawn to scale. Understanding that these drawings depict only exemplary embodiments of the disclosure and are not therefore to be considered limiting of its scope, the principles herein are described and explained with additional specificity and detail through the use of the accompanying drawings in which:

FIG. 1 is a diagram of a musical training system in one example.

FIG. 2 is a flowchart for a method for musical training in one example.

FIG. 3 illustrates an example of a deep learning neural network that can be used to implement a machine learning-based finger alignment prediction.

FIG. 4 is a diagram illustrating an example of a computing system.

FIG. 5 illustrates a wearable device in one example.

Reference characters indicate corresponding elements among the views of the drawings. The headings used in the figures do not limit the scope of the claims.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment”, “an embodiment”, or “an aspect” means that a particular feature, structure, or characteristic described in connection with the embodiment is included in at least one embodiment of the disclosure. The appearances of the phrase “in one embodiment” or “in one aspect” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

As used herein, “about” refers to numeric values, including whole numbers, fractions, percentages, etc., whether or not explicitly indicated. The term “about” generally refers to a range of numerical values, for instance, ±0.5-1%, ±1-5% or ±5-10% of the recited value, that one would consider equivalent to the recited value, for example, having the same function or result.

The term “substantially” is defined to be essentially conforming to the particular dimension, shape or other word that substantially modifies, such that the component need not be exact.

The terms “comprising,” “including” and “having” are used interchangeably in this disclosure. The terms “comprising,” “including” and “having” mean to include, but not necessarily be limited to the things so described.

The term “coupled” as used herein is defined as connected, whether directly or indirectly through intervening components, and is not necessarily limited to physical connections. The connection can be such that the objects are permanently connected or releasably connected.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Provided herein are musical training systems and methods that provided detailed and personalized training to a user, without the need for an instructor. The musical training systems and methods can provide real-time feedback to the user, while the user is playing, through the use of edge computing or networked systems. The musical systems and methods can include wearable devices configured to track finger movements of the user while the user is playing and also provide feedback to guide the user's learning and progression to becoming a better musician. In some examples, the systems can use machine learning models and/or other data analysis techniques to develop and provide real-time feedback based on user finger movement.

The musical training system can be used to train musicians to play chord instruments such as violins, cellos, or other chord instruments. The musical training system described herein can also be used to train musicians on key instruments such as pianos, keyboards, or other key instruments.

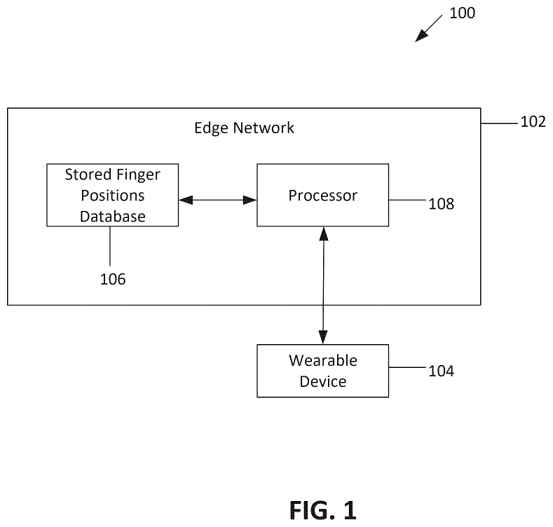

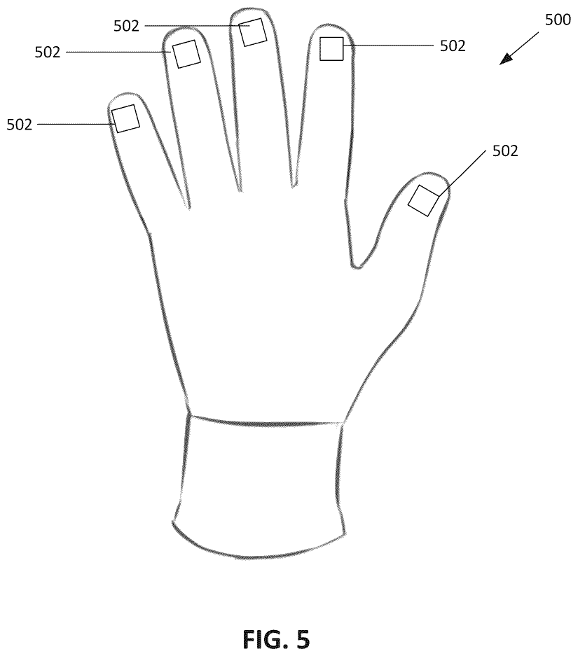

FIG. 1 illustrates an example of a musical training system 100. The musical training system 100 can include an edge network 102. The edge network 102 can include a stored finger positions database 106 and one or more processors 108. The stored finger positions database 106 can include a plurality of finger positions for a plurality of songs from a plurality of musicians. The musical training system 100 can further include a wearable device 104. The wearable device 104 can be in communication with one or more processors 108 to send and receive data via the edge network 102. In some examples, the wearable device 104 can be a glove or other device operable to attach to a user's hand or fingers. In some examples, the musical training system 100 includes two wearable devices 104, one for each hand of a user. In some examples, as illustrated in FIG. 5, the wearable device 104 can include a glove 500 having one or more sensors 502. In some examples, the one or more sensors 502 can each include an actuator configured to provide haptic feedback, as described herein.

The wearable device 104 can be configured to track a user's finger positions while the musician is playing the instrument. Finger positions are tracked in the time domain such that nuanced movements are tracked and recorded. The wearable device can include one or more sensors (e.g., one or more sensors 502) for tracking the user's finger position. In some examples, the one or more sensors are motion sensors. In some examples, the one or more sensors can be inertial measurement unit sensors (IMU) comprising accelerometers, gyroscopes, and magnetometers. For example, the one or more sensors can be operable to track motion, such as acceleration, orientation, velocity, and spatial position trajectory either by position receivers or by algorithms to determine values based on sensor data. In some examples, the one or more sensors can include flex sensors operable to determine a pressure that the user is exerting on the instrument in a specific location.

In some examples, the one or more sensors can be capacitive sensors. Capacitive sensors can detect the presence or motion of a human body part, such as a finger, with high precision. Capacitive sensors measure changes in capacitance caused by the proximity or movement of an object, allowing for very fine control and feedback.

In some examples, the one or more sensors can be optical sensors. Optical sensors can include cameras or infrared light. In some examples, optical sensors can include optical tracking systems. Optical sensors can achieve very high precision. Optical sensors can track the movement of specific markers or the user's hands in 3D space, providing detailed positional data down to the submillimeter level.

In some examples, the one or more sensors can be magnetic sensors (e.g., magnetic tracking sensors. Magnetic sensors can be operable to generate magnetic fields and detect distortions caused by the presence of a magnetic object or sensor (e.g., on various locations on the wearable device 104). Magnetic sensors can accurately track the position and orientation of a device or limb. Magnetic sensors can be extremely precise, offering submillimeter resolution in tracking finger positions.

In some examples, the one or more sensors can include ultrasonic sensors. Ultrasonic sensors use high-frequency sound waves to detect the position and movement of objects such as fingers and strings. For example, the ultrasonic sensors can transmit sound waves and measure the time it takes the sound waves to return. Ultrasonic sensors can thereby track both finger and string position. By measuring the time it takes for the sound waves to return, ultrasonic sensors can precisely calculate distances and movements, providing the precise haptic feedback described herein.

In some examples, the one or more sensors can include force sensors (e.g., load cells). Force sensors can detect very slight forces and pressure changes, translating them into electrical signals that can be used to adjust haptic feedback in real-time, allowing for nuanced control down to the submillimeter level. Force sensors can also be operable to track minor variations (via measured forces) in a user's fingers while playing, thereby accurately capturing movement at the submillimeter level.

In some examples, the one or more sensors can be electromagnetic tracking systems. Electromagnetic tracking systems can use electromagnetic fields to determine the position and orientation of a sensor relative to a transmitter with very high precision and without the need for line-of-sight, which provides for intricate haptic feedback.

The one or more sensors can also include wireless technology to track finger with submillimeter accuracy. Using wireless signals to track submillimeter movements is an active area of research in the field of entomology, robotics, and wireless communication. The technique often involves a combination of technologies, including, but not limited to, Radio Frequency (RF) identification, radar, and wireless sensor networks.

Radio frequency identification (RFID) tags can be attached to fingernails allowing finger movements to be tracked with precision. While traditional RFID systems may not achieve sub-millimeter accuracy, advancements in ultra-high frequency (UHF) RFID and improvements in reader sensitivity and tag antenna design can be configured to achieve submillimeter accuracy.

Advanced radar systems, such as micro-doppler radars, can detect very fine movements, and can be used to track very minute movements to the submillimeter level. These advanced radar systems can emit radio waves and then analyze the echoes returned from the target. In some examples, noise filters and/or the machine learning model described herein can be used to eliminate noise from the echoes, thereby allowing for submillimeter tracking.

A network of wireless sensors operable to generate millimeter and/or sub terahertz waves can be deployed around an area of interest, and finger position can be detected and triangulated to a transmitter on a finger. These wireless networks can utilize advanced transmitters and sensors as well as advanced signal processing algorithms to increase accuracy at the submillimeter level.

Millimeter wave transmitters can transmit at frequencies between 30 GHz and 300 GHz and have the potential for high-resolution tracking due to the ability to resolve very small movements due to the short wavelength of millimeter waves.

In some examples, the one or more sensors are operable to track user finger position at a submillimeter level, such that a precise location of the user's fingers during the entirety of the song is tracked. This level of precision provides detailed analysis of the user's playing ability, because even minute variations in finger placement can significantly alter the sound produced. By accurately capturing the user's finger position and movement, the wearable device 104 can record the exact positioning and motion of the user's fingers while playing.

In some examples, finger position includes timing and motion as determined by the difference in finger position. Finger position data can also provide movement of the user. In instrumental training, motions can be faced paced and nuanced. Tracking finger position can also include tracking the fast paced and nuanced movement between positions.

In some examples, the musical training system 100 can include a camera, machine vision system, or other systems operable to track user finger positions. For example, the camera, machine vision system, or other systems can be configured to locate and track markers (e.g., transmitters, etc.) on the wearable device 104 to determine the user finger position. In some examples, the camera, machine vision system, or other systems operable to track user finger positions can be configured to determine user finger position without directly interacting with the wearable device 104 (e.g., the camera, machine vision system, or other systems can be operable to track the user finger positions without using the wearable device 104 as a reference). For example, machine vision systems can be operable to determine user finger position simply by tracking the position of the user's fingers based on known reference points. In some examples, the machine vision system can be trained to determine the user's finger positions in reference to the known dimensions and positions of an instrument.

It will be appreciated that any of the sensors described herein can be used alone or in conjunction with one another. For example, various combinations of the sensors can be selected to generate a wearable device that is optimized for submillimeter tracking of finger position and movement.

In some examples, the wearable device 104 can include a haptic feedback mechanism. The haptic feedback mechanism can be operable to provide haptic feedback (e.g., tactile feedback) to the user based on the user's finger positioning. If one or more of the user's fingers are out of position, the haptic feedback mechanism can provide a directed vibration to guide the user's fingers to the correct positioning. For example, the haptic feedback can provide a vibration in the direction the user should move their finger or fingers to produce the correct sound at the correct moment of time while playing the song.

In some examples, the haptic feedback mechanism can include one or more actuators for each finger of the user's hand. The actuators can be in communication with the one or more processors 108, such that the one or more processors 108, through the edge network 102, can cause the actuators to provide the directional vibrations to guide the user's fingers to the correct positions during the song. In some examples, the actuators do not provide the directional vibrations when the user's fingers are in the correct finger positions.

In some examples, the wearable device 104 can be configured such that it is comfortable on a hand of the user and does not impede the natural movement of the user during training.

In some examples, the system 100 can further include an audio device. The audio device can be in communication with the one or more processors 108 and receive data via the edge network 102. In some examples, the audio device can be an earpiece, earplug, headset, or other wearable audio device. The audio device can be configured to provide real-time feedback to the user. For example, the audio device can be configured to provide audio feedback such as instructions to move one or more fingers to an optimal finger position, such as the stored finger positions discuss herein.

The audio device can further be configured to record sounds produced by the musical instrument. In some examples, the recorded sounds can be stored and later analyzed by a machine learning model, data analysis module, or other computer programs to provide detailed feedback to the user. In some examples, the audio device can also send data to the one or more processors 108 in real-time through the edge network 102.

The stored finger positions database 106 can include a plurality of songs with stored optimal finger positions. In some examples, each song can have finger positions recorded in a time domain, such that the stored finger positions database 106 knows exactly where a user's fingers should be positioned at any given moment in time during a selected song. In some examples, the finger positions in the time domain for each song in the stored finger positions database 106 are generated by one or more skilled musicians. For example, a single skilled musician's finger position for a selected song can be tracked using the wearable device 104 and then stored in the stored finger positions database 106. When a user is ready to train on a selected song, the user can begin the song and the haptic feedback mechanism can provide haptic feedback, via the one or more processors 108, edge network 102, and stored finger positions database 106 to guide the user's finger position to the stored finger positions at the correct times based on the user's tracked finger positions.

In some examples, each song in the stored finger positions database can be generated by a machine learning model. For example, the stored finger positions database can generate optimal stored finger positions in the time domain for each song based on a plurality of skilled musicians tracked finger positions. A plurality of musicians' finger positions can be tracked using the wearable device 104. This finger position data can then be input into a trained machine learning model having one or more neural networks to determine optimal finger positions in a time domain. For example, the trained machine learning model can be configured to compare the similarities between the plurality of musicians' tracked finger position data and determine optimal finger positions in a time domain for a given song.

In some examples, the stored finger positions database 106 can be generated by data analysis algorithms. For example, a data analysis algorithm can be configured to determine optimal finger positions in a time domain for a given song.

In some examples, the stored optimal finger positions in the stored finger positions database 106 can be optimal finger positions and timing for a given musical note. For example, each musical note can have an optimal finger position. In some examples, the stored optimal finger positions can be stored optimal finger positions and timing for a transition between a first musical note and a second musical note. In some examples, the stored optimal finger positions can be stored optimal finger positions and timing for a sequence of musical notes (e.g., a first musical note transitioning to a second note and optionally one or more additional transitions and musical notes). In this manner, the stored finger positions database 106 can be operable to analyze and combine multiple musical notes and transitions so a user can practice certain sequences. By storing musical note finger positions and transitions between notes, the amount of stored finger position data can be increased, thereby allowing for further analysis and optimization.

The musical training system 100 can further include a display. The display can include a graphical user interface to allow a user to select a song for training. The display can also be operable to display various performance statistics, reports (e.g., training scores), and personalized training recommendations as described herein.

The one or more processors can be configured to communicate with the stored finger positions database 106 and the wearable device 104 in real-time via the edge network 102. In some examples, the one or more processors 108 can have one or more modules for processing data in the edge network 102. The one or more modules can include the stored finger positions database 106, a machine learning module (e.g., machine learning model), a data analysis module, and other modules.

The edge network 102 allows for real-time finger tracking and real-time haptic feedback. For example, the edge network 102 can allow for the real-time processing and determination of a user's finger position via the one or more processors 108. The one or more processors 108 can receive user finger positions from the wearable device 104. The user finger positions can then be compared to the stored optimal finger positions in the stored finger positions database 106. The one or more processors 108 can then cause the wearable device 104 to provide haptic feedback (e.g., direction nudge or vibration) to the user to guide one or more of the user's fingers to the optimal finger position at a given time in the song. The edge network 102 can allow the real-time collection of the user's finger position, comparison of the user's finger position to the stored optimal finger positions, and haptic feedback. In this manner, real-time feedback can be provided to the user, thereby providing training while the user is practicing.

The edge network 102 refers to edge computing, which means processing data near the location where it is generated. By processing the data near the location where it is generated, the data can be rapidly processed in real-time. The edge network 102 is operable to rapidly process the data (e.g., user finger position), thereby minimizing latency and allowing for real-time haptic feedback. The real-time processing by the edge network 102 is highly beneficial for providing instant feedback to the user and for capturing data accurately during the fast-paced motions of the user while playing a song.

In some examples, the machine learning module (e.g., machine learning model) can be configured to determine the haptic feedback provided to the user using a machine learning model. For example, the machine learning model can be trained on the data in the stored finger positions database 106 with a plurality of finger positions in a time domain from a plurality of musicians for a plurality of songs. The machine learning model can process the received finger positions from the user and determine amount, direction, and timing of the haptic feedback. For example, the machine learning model can determine that a user's finger position is a certain distance from an optimal finger position and provide a vibration nudging or pushing the user's finger towards the desired position. It will be appreciated that the machine learning model can be operable to determine the optimal position of all of the user's fingers at any given time and the wearable device 104 can provide haptic feedback to multiple fingers at a time.

In some examples, the machine learning module (e.g., machine learning model) or a data analysis module can be configured to analyze the vast amount of data generated by finger tracking to identify patterns and insights into optimal playing techniques. For example, the machine learning module (e.g., machine learning model) and/or data analysis module can be configured to determine patterns or rhythms from skilled musician finger position and movement data and provide these patterns or rhythms to the user to train the user.

In some examples, the one or more processors 108 can be configured to generate feedback after a song or a practice session that includes a plurality of songs. For example, the one or more processors 108 can use the comparison data between the tracked user finger positions and the optimal finger positions to generate reports (e.g., training scores). The reports can include information including a percentage and/or number of missed notes, an analysis of the accuracy of the user's finger positions as compared to the optimal finger positions, and other information indicative of the user's performance. The one or more processors 108 can also generate personalized training recommendations. For example, the personalized training recommendation can indicate certain notes, rhythms, or patterns that the user struggles with. The personalized training recommendations can provide one or more songs for the user to practice to further refine skills that are lacking. In some examples, the display can also display one or more past training scores such that the user can view their progress. The personalized training recommendations can take into account the user's progress and previous training scores.

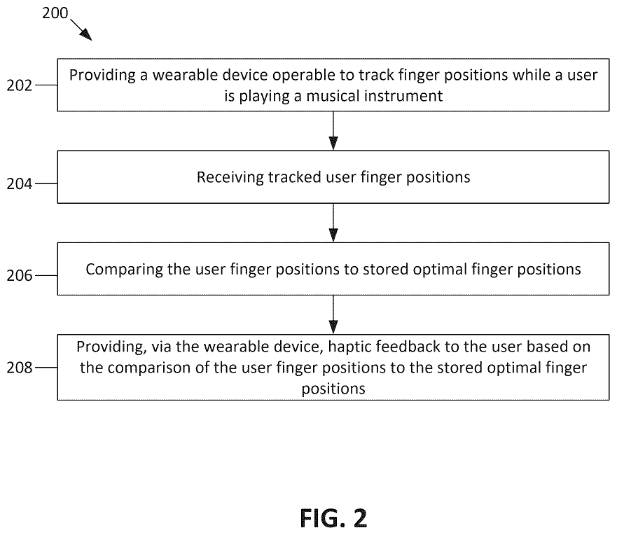

Further provided herein is a method for training a user to play an instrument. FIG. 2 illustrates a method 200 for musical training in one example.

At block 202, the method 200 can begin by providing a wearable device operable to track finger position while a user is playing a musical instrument. In some examples, the wearable device can be associated with an edge network. In some examples, the wearable device can be operable to track user finger position at a submillimeter level. In some examples, the wearable device is a glove having one or more sensors and one or more actuators. In some examples, the one or more sensors can be operable to track user finger positions and the one or more actuators are operable to provide haptic feedback. In some examples, the method can include providing two wearable devices, one for each hand of the user.

At block 204, the method 200 can include receiving tracked user finger positions. In some examples, the tracked user finger positions can be received at one or more processors that are connected to an edge network.

At block 206, the method 200 can include comparing the user finger positions to stored optimal finger positions. Comparing the user finger positions to the stored optimal finger positions can be processed by the one or more processors. The one or more processors can be connected to the edge network. The edge network can allow for the comparison of the user finger positions to the stored optimal finger positions in real-time. The edge network can allow the comparison between the user finger positions and the optimal finger positions near the location where the user finger positions were taken (e.g., near the user), thereby allowing rapid processing of the comparison and minimizing latency.

In some examples, the stored optimal finger positions can be recorded in a time domain. The stored optimal finger positions can be generated before the method 200 begins. In some examples, the stored optimal finger positions include finger positions tracked from a skilled musician playing a song or a plurality of songs. In some examples, the stored optimal finger positions can include a plurality of tracked finger positions from a plurality of musicians for a plurality of songs. The plurality of finger positions for the plurality of musicians can be combined and optimized to the optimal finger positions for each song using a machine learning model and/or data analysis algorithms as described herein.

At block 208, the method 200 can include providing, via the wearable device, haptic feedback to the user based on the comparison of the user finger positions to the stored optimal finger positions. In some examples, the haptic feedback can include tactile feedback. The haptic feedback can be provided in real-time by the one or more processors to the wearable device via the edge network. In some examples, the haptic feedback includes directed vibrations to nudge a user's fingers to the stored optimal finger positions at a given time.

In some examples, the method 200 can further include determining a training score based on the comparison of the user finger positions and the stored optimal finger positions. The training score can include information including a percentage or number of missed notes, an analysis of the accuracy of the user's finger positions as compared to the optimal finger positions, and other information indicative of the user's performance. The method 200 can also include generating personalized training recommendations. For example, the personalized training recommendation can indicate certain notes, rhythms, or patterns that the user struggles with. The personalized training recommendations can provide one or more songs for the user to practice to further refine skills that are lacking.

In some examples, the method 200 can further include outputting the training score on a display. For example, the training score and/or personalized training recommendations can be displayed on a display such that a user can view the training scores. In some examples, the display can also display one or more past training scores such that the user can view their progress. The method 200 can take into account the user's progress in generating the personalized training recommendations.

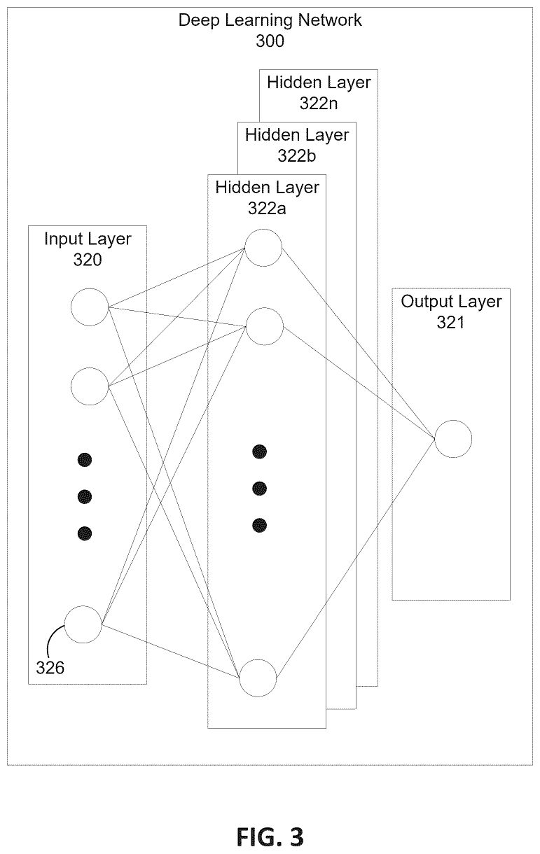

Various aspects of the present disclosure can use machine learning models or systems. FIG. 3 is an illustrative example of a deep learning neural network 300 that can be used to implement the machine learning-based alignment prediction described herein. An input layer 320 includes input data. In one illustrative example, the input layer 320 can include data representing the finger positions of the user. The neural network 300 includes multiple hidden layers 322a, 322b, through 322n. The hidden layers 322a, 322b, through 322n include “n” number of hidden layers, where “n” is an integer greater than or equal to one. The number of hidden layers can be made to include as many layers as needed for the given application. The neural network 300 further includes an output layer 321 that provides an output resulting from the processing performed by the hidden layers 322a, 322b, through 322n. In one illustrative example, the output layer 321 can provide a classification for a finger position in finger position input data. The classification can include a class identifying the type of activity or object (e.g., finger positions for certain musical notes, etc.).

The neural network 300 is a multi-layer neural network of interconnected nodes. Each node can represent a piece of information. Information associated with the nodes is shared among the different layers and each layer retains information as information is processed. In some cases, the neural network 300 can include a feed-forward network, in which case there are no feedback connections where outputs of the network are fed back into itself. In some cases, the neural network 300 can include a recurrent neural network, which can have loops that allow information to be carried across nodes while reading in input.

Information can be exchanged between nodes through node-to-node interconnections between the various layers. Nodes of the input layer 320 can activate a set of nodes in the first hidden layer 322a. For example, as shown, each of the input nodes of the input layer 320 is connected to each of the nodes of the first hidden layer 322a. The nodes of the first hidden layer 322a can transform the information of each input node by applying activation functions to the input node information. The information derived from the transformation can then be passed to and can activate the nodes of the next hidden layer 322b, which can perform their own designated functions. Example functions include convolutional, up-sampling, data transformation, and/or any other suitable functions. The output of the hidden layer 322b can then activate nodes of the next hidden layer, and so on. The output of the last hidden layer 322n can activate one or more nodes of the output layer 321, at which an output is provided. In some cases, while nodes (e.g., node 326) in the neural network 300 are shown as having multiple output lines, a node has a single output and all lines shown as being output from a node represent the same output value.

In some cases, each node or interconnection between nodes can have a weight that is a set of parameters derived from the training of the neural network 300. Once the neural network 300 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 300 to be adaptive to inputs and able to learn as more and more data is processed.

The neural network 300 is pre-trained to process the features from the data in the input layer 320 using the different hidden layers 322a, 322b, through 322n in order to provide the output through the output layer 321. In an example in which the neural network 300 is used to identify finger positions in relation to an instrument, the neural network 300 can be trained using training data that includes both finger positions and instrument locations, as described herein. For instance, training data including finger positions and instrument locations (e.g., finger positions in reference to a location on an instrument) can be input into the network, with each training frame having a label indicating the features of the positions (for a feature extraction machine learning model) or a label indicating classes of an activity in each frame.

The neural network 300 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 300 can include any other deep network other than a CNN, such as an autoencoder, a deep belief nets (DBNs), a Recurrent Neural Networks (RNNs), BNNs, among others.

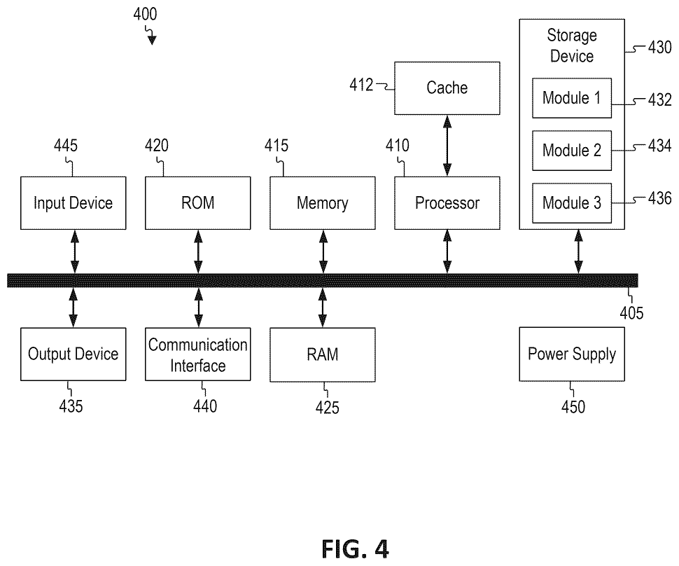

FIG. 4 shows an example of computing system 400, which can be for example any computing device making up various parts of the musical training system, or any component thereof in which the components of the system are in communication with each other using connection 405. Connection 405 can be a physical connection via a bus, or a direct connection into processor 410, such as in a chipset architecture. Connection 405 can also be a virtual connection, networked connection, edge network connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read-only memory (ROM) 420 and random-access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 432, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 425, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 420, which can generally govern and manage the user input and system output. There is no restriction on operating on any particular hardware arrangement, and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network (e.g., edge network). The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

The disclosures shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the examples described above may be modified within the scope of the appended claims.

What is claimed is:

1. A musical training system associated with an edge network, the musical training system comprising:
a wearable device operable to track user finger positions and provide haptic feedback to a user;
one or more processors connected to the edge network; and
a memory storing instructions that, when executed by the one or more processors, causes the one or more processors to:
receive the user finger positions from the wearable device;
compare the user finger positions to stored optimal finger positions; and
cause the wearable device to provide haptic feedback to the user based on the comparison of the user finger positions to the stored optimal finger positions.

2. The musical training system of claim 1, wherein the wearable device is operable to track user finger position at a submillimeter level.

3. The musical training system of claim 1, wherein the wearable device is a glove having one or more sensors and one or more actuators.

4. The musical training system of claim 3, wherein the one or more sensors are operable to track the user finger positions and the one or more actuators are operable to provide the haptic feedback.

5. The musical training system of claim 1, wherein the stored optimal finger positions are finger positions collected from a skilled musician playing a song.

6. The musical training system of claim 1, wherein the edge network is configured to allow comparison of the user finger positions to the stored optimal finger positions in real-time.

7. The musical training system of claim 1, wherein the haptic feedback comprises a directed vibration to instruct the user to move one or more fingers in a desired direction towards the stored optimal finger positions in real-time.

8. The musical training system of claim of claim 1, wherein the stored optimal finger positions comprise tracked finger positions from a plurality of musicians for a plurality of songs.

9. The musical training system of claim 8, wherein the tracked finger positions from the plurality of musicians are analyzed by a machine learning model to form the stored optimal finger positions for each song in the plurality of songs.

10. The musical training system of claim 1, wherein the one or more processors are further configured to:
determine a training score based on the comparison of the user finger positions and the stored optimal finger positions; and
output the training score on a display.

11. A method for musical training, the method comprising:
providing a wearable device operable to track user finger positions while a user is playing a musical instrument, wherein the wearable device is associated with an edge network;
receiving the user finger positions;
comparing the user finger positions to stored optimal finger positions; and
providing, via the wearable device, haptic feedback to the user based on the comparison of the user finger positions to the stored optimal finger positions.

12. The method of claim 11, wherein the wearable device is operable to track user finger position at a submillimeter level.

13. The method of claim 11, wherein the wearable device is a glove having one or more sensors and one or more actuators.

14. The method of claim 13, wherein the one or more sensors are operable to track the user finger positions and the one or more actuators are operable to provide the haptic feedback.

15. The method of claim 11, the method further comprising receiving finger positions from a skilled musician playing a song, wherein the stored optimal finger positions are the finger positions from the skilled musician.

16. The method of claim 11, wherein the edge network is configured to allow comparison of the user finger positions to the stored optimal finger positions in real-time.

17. The method of claim 11, wherein providing the haptic feedback comprises providing a directed vibration to instruct the user to move one or more fingers in a desired direction towards the stored optimal finger positions in real-time.

18. The method of claim 11, the method further comprising receiving tracked finger positions from a plurality of musicians for a plurality of songs.

19. The method of claim 18, wherein the tracked finger positions from the plurality of musicians are analyzed by a machine learning model to form the stored optimal finger positions for each song in the plurality of songs.

20. The method of claim 11, the method further comprising:
determining a training score based on the comparison of the user finger positions and the stored optimal finger positions; and
outputting the training score on a display.
